(19) United States
(12) Patent Application Publication
(10) Pub. No.: US 2010/0260980 A1
(43) Pub. Date: Oct. 14, 2010

(54) METHOD FOR PRODUCING A MOLDED PART COMPRISING DIFFERENT DECORATIVE ZONES

(75) Inventor: Hans Schirmer, Heiteren (FR)

Correspondence Address: URSULA B. DAY, ESQ., 708 Third Avenue, SUITE 1501, NEW YORK, NY, 10017, US

(73) Assignee: Peguform GmbH, Bötzingen (DE)

(21) Appl. No.: 12/676,787

(22) PCT Filed: Aug. 25, 2008
(86) PCT No.: PCT/EP2008/006952

§ 371 Date: May 19, 2010

(30) Foreign Application Priority Data
Sep. 7, 2007 (EP) 07017560.9

(51) Int. Cl. B32B 3/10; B29C 45/14; B29C 47/92

(52) U.S. Cl. 428/201; 264/279; 425/159

(57) ABSTRACT

The invention relates to a simple method for producing molded parts including different decorative zones. According to said method, the molded part can be produced without changing the mold by step-wise back-molding, using cascade control.

The present invention refers to a method for the production of a molded part having different decorative zones according to the preamble of claim 1, as well as a device for the production of such molded parts and the use of the molded part in interior paneling of automotive vehicles, in particular for dash boards, for side paneling or door paneling.

It is known to back injection mold woven textile materials, plastic foils, felt—or carpet materials, leather or imitation leather or similar materials which, besides their utilization in decoration, can also have a special technical function, whereby the woven textile or the decorating foil is placed into a mold and then back molded with liquefied thermoplastic material.

In EP 1 655 122 A1, a method is described for the production of a plastic part by back injection molding, back compression molding or injection compression molding of at least a woven textile, decorating fabric, a plastic foil, a carpet fabric or another flexible material by means of a mold. There, in a first process, a first woven textile is back injection molded in a first mold. Subsequently, a section from the so produced semi finished product is punched out and then a second woven textile is placed in the tool at the site where the first section was removed, whereupon the semi finished product is again back injection molded at least at the location of the second woven textile.

A drawback of this method is such that several process steps are necessary in order to obtain a molded part with different decorative zones. An additional drawback results, as described in a preferred embodiment, when work is carried out without changing the mold, since the mold, during the punching step, might be damaged though the punching tool.

In the German Patent Publication DE 10 2005 029 849 A1, a method for the production of a composite element for the motor vehicle body is described, wherein at least two flat portions of an outer skin are placed side by side in a common mold and in the tool is provided with a common support structure across their entire surface. The embodiments as described in the publication are especially suitable for producing vehicle body elements, especially for the roof area, in which the outer skin is divided into at least two surfaces. The method also provides that portions of the outer skin are placed into the mold as separate sections, whereby neighboring portions of the outer skin can overlap in a sealing manner.

In the area of the overlap, certain measures are applied to prevent an oozing or penetration of the pasty plastic component of the support structure to the viewing side. Thus, the overlapping areas, for example, are pressed together in a sealing manner by means of creating a negative pressure. Besides that, the document also illustrates a series of additional means to seal the overlapping areas, such as for example groove connections, depressions in the marginal area or step formation in the marginal area.

A drawback of this method is the need to apply further measures in order to seal the marginal area and to prevent penetration of the pasty plastic mass to the viewing side. Unless these measures are taken, there is an acute danger that the support material reaches the viewing side and as a result, the form parts are no longer usable and end up in the reject bin.

In addition, measures for sealing are oftentimes very complex in their construction and the transition area between the different surfaces oftentimes coincides with the strict optical boundary between each of the surfaces. This is tolerable in the exterior—and body area since in this area such transitions are partially desired or they can be hidden through suitable means such as the placement of a cover strip. In general, courser transitions and structures are more acceptable in the exterior area of a motor vehicle than in the interior area. For the production of molded parts for the interior paneling of motor vehicles, in particular dash boards, side paneling or door paneling, the method as described in DE 10 205 029 849 A1 is either not suitable or only conditionally suitable.

Thus, the object remains to find an uncomplicated and easy method for the production of molded parts having different decorating zones, in particular, for interior paneling of motor vehicles.

This object is solved by a method with the features of claim 1. Preferred embodiments of the method according to the invention are reflected in the dependent claims.

Object of the present invention includes a device for the production of molded parts having different decorating zones as well as the use of such molded parts as interior paneling for motor vehicles such as dashboards, side paneling and door paneling.

The essential steps of the method according to the invention comprises the placement and positioning of at least one decorating foil into a mold, whereby decorating foil should be understood as including all materials that are utilized for decoration, in particular for the interior paneling of motor vehicles, such as for example woven textiles, decorating fabrics, plastic foils, carpet fabrics, leather and imitation leather.

After being placed into the mold, the decorating foil, according to an advantageous embodiment of the present invention, can be positioned and fixed in the mold by means of pins. In case it is contemplated that the decorating zone should extend to the edge of the molded part, a positioning can also advantageously take place via elements that are outside the mold cavity.

In a subsequent work step, at least a first decorating foil is being back molded with a thermoplastic material to such a degree, that the marginal area of the decorating foil is sealed through overflow, Only then, the remainder of the mold is filled in a time-delayed manner, and the second decorating zone also back molded. By means of the primary overflow into the marginal area, that area is sealed and in the later form finishing step there is no danger that material reaches the viewing area of the molded part due to mounting pressure of the plastic melt.

Technically, the problem is solved by a cascade controlled injection of the plastic support material, by means of which it is, for example, possible that the injection nozzles in the different areas in the mold open at staggered times. It is also possible to position the nozzles of the mold in such a way that the second decorating zone is back molded per se in a time staggered manner.

The back molding itself can be accomplished by back injection molding, back foaming, back compression molding or injection-compression.

As support material for the decorating foil, thermoplastic material, such as for example polypropylene (PP), polyethylene (PE), polyurethane (PU), acryl-nitril-butadiene-styrenes (ABS), polyamid (PA) but also co-polimerisates such as acryl-nitril-butadiene-styrene/polycarbonate (ABS-PC) is contemplated, wherein the plastic material in pure form is utilized and advantageously, also together with fibers, such as for example glass fibers, natural fibers or carbon fibers or other reinforcement materials.

The simplest embodiment of the present invention provides that the surface of a first decorating zone is formed by means of a decorating foil, while a second decorating zone is directly formed after a partial back molding of the first decorating zone at the surface of the thermoplastic material. For this purpose, the surface of the mold can, for example, include corresponding decorating elements, such as grains or similar which are then imaged on the plastic surface.

A preferred embodiment of the present invention provides that different decorating foils are utilized wherein the first decorating foil is placed into the tool mold and positioned; thereafter, a second decorating foil is placed into the mold in such a way that the marginal area of the second foil is overlapped by the first decorating foil. In this case also, the different decorating foils are being fixed and positioned in the mold by means of pins.

In a subsequent work step, the overlapping first decorating foil is back molded with a thermoplastic material to such an extent that the overlapping area is sealed through overflow. Only then and in a time delayed manner, the second decorating foil is back molded.

In a preferred embodiment of the afore-described variant of the method according to the invention, it is provided that the second decorating foil, except the area which is already covered by the first decorating foil, covers the entire surface of the mold.

In a further variant, it is provided that the additional areas of the mold remain free and can be covered by one or more additional decorating foils in such a manner that each of the decorating foils are overlapped by the preceding foil. The back molding is carried out in a cascade controlled way starting with the decorating foil which was placed last.

In the afore-described embodiments, areas in the mold can also remain entirely free. Such an area can then be subjected to the cascade controlled back molding last, so that the decorating image forms again an image at the surface of the thermoplastic material.

The overlapping area of the decorating foils amounts to 1 to 60 mm, whereby an overlap between 10 and 20 mm has proven to be especially advantageous for the safety of the method and also with respect to the resulting optical appearance.

In the following paragraphs, the present invention will be described in more detail by means of drawings, which show in:

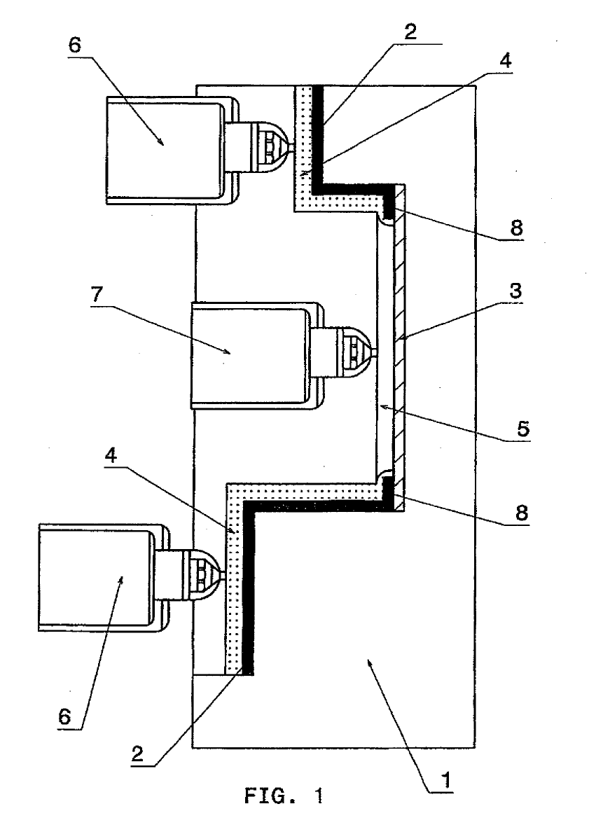

FIG. 1 a section through a mold after a first processing step of the back molding;

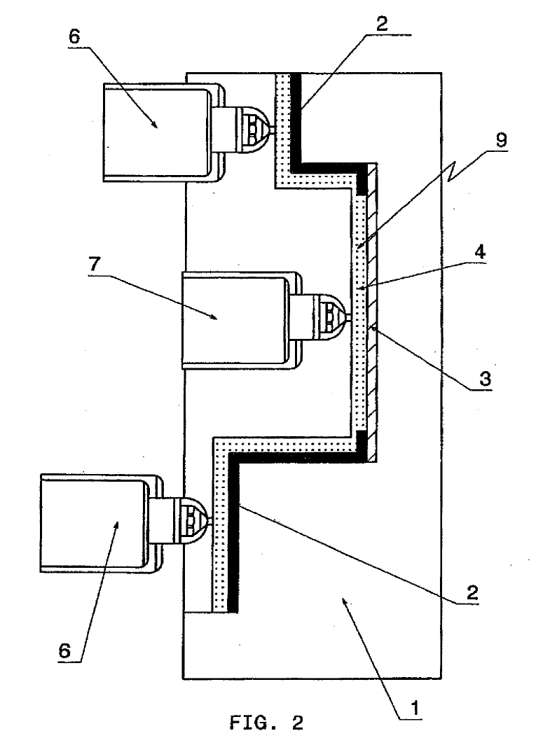

FIG. 2 a section through the mold of FIG. 1, after completion of the molded part;

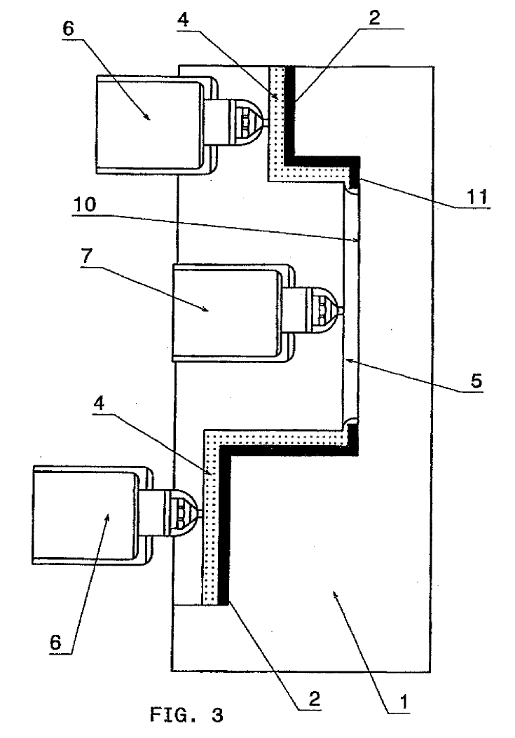

FIG. 3 a section through a mold according to a first processing step of the back molding;

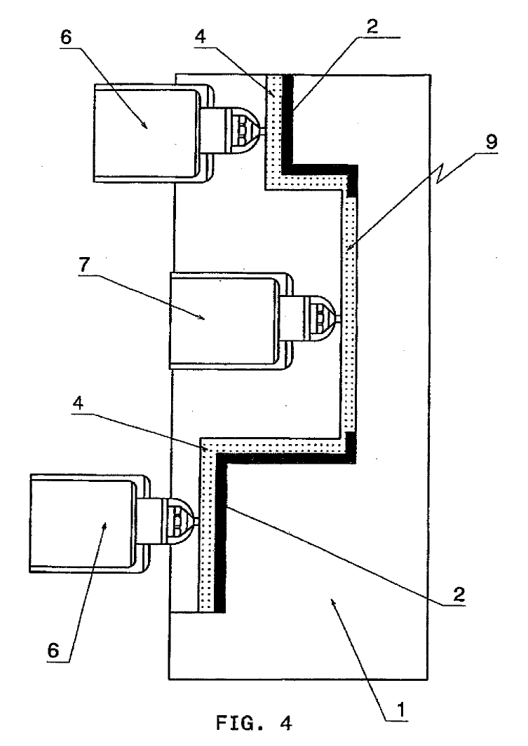

FIG. 4 a section through the mold of FIG. 3 after completion of the molded part.

FIG. 1 shows a closed mold 1 with two different decorating foils 2, 3 placed therein. The decorating foils 2, 3 can be from different materials such as textiles, plastic foils, carpets, leather or imitation leather. The section through the mold 1 shows the point in time of a first processing step of the back molding, where the decorating foil 2 is already back molded by support material 4, while the decorating foil, with the exception of its marginal area 3, remains free in the cavity 5. In the overlapping areas 8, an overflow of the support material 4 is shown, by means of which the sealing of this area is realized. In this first processing step of the back molding, only the nozzles 6 were activated, while no material has reached the mold via the injection nozzle 7. The materials for the support include thermoplastic materials, such a s for example polypropylene (PP), polyethylene (PE), polyurethane (UP), acrylnitril-butadiene-styrene/polycarbonate copolymerisate (ABS-PC) and polyamid, wherein an advantageous embodiment of the present invention these materials together with the reinforcement materials such as, for example, glass fiber, natural fibers or carbon fibers, can be utilized.

FIG. 2 shows the completed molded part 9 in the still closed mold 1. In this case, both decorating foils 2 and 3 are back molded with the support material 4, wherein the back molding of decorating foil 3 has been essentially carried out by injection nozzle 7.

FIG. 3 shows a closed mold, in which only a decorating foil 2 has been placed. A surface area 10 of the mold 1 remains free. Here, the decorating foil 2 also includes different materials such as textiles, plastic foils, carpets, leather or leather imitations. The section through the mold captures a moment in time of a first processing step of the back molding where the decorating foil 2 is already completely back molded by the support material 4, while the surface area 10, with the exception of the marginal area 11 of the decorating foil 2 remains still free in the cavity 5. In the marginal areas 11, an overflow of support material 4 is seen, to thereby realize the sealing of this area. In this first processing step of the back molding, only nozzles 6 were activated, while no material reaches yet the mold 1 via the injection nozzle 7. The injection nozzle 7 is activated for a brief period in a time-delayed manner, so that also in the area of the direct contact with the mold surface 10, an even formation of the molded part surface is realized. By means of a corresponding structuring of the surface 10 of the mold, such as, for example, a grain or similar, the corresponding decorating zone can now be directly formed on the support material 4 of molded part 9. The completed molded part 9 is shown in FIG. 4. Materials for the support again include thermoplastic materials, such as for example polypropylene (PP), polyethylene (PE), polyurethane (PU), acrylnitril-butadiene-styrene/polycarbonate copolymerisate (ABS-PC) and polyamid (PA), wherein in an advantageous embodiment, these materials can be combined with reinforcement materials such as for example glass fibers, natural fibers or carbon fibers.

In FIGS. 1 to 4 only two embodiments of the present invention are shown in order to illustrate the general principle. Additional variants of the tool, the formation of the transition areas, the cascading arrangement of the nozzles or the type of back molding are known to the person skilled in the art and are included in the following claims.

### REFERENCE NUMERAL LIST

1 mold

2 first decorating foil

3 second decorating foil

4 support

5 cavity

6 first nozzle

7 second nozzle

8 overlap area

9 molded part

10 mold surface

11 marginal area

1. Method for the production of a mold part (9) having different decorative zones and including the steps of:
a) placing and positioning at least one decorative foil into a mold for developing a surface of a first decorating zone,
b) partial back injection molding of at least one decorative foil with a thermoplastic material as a support and
c) subsequently, back forming the second decorative zone,
characterized in that the margin area of the decorative foil is sealed through overflow, whereby the stepwise back molding of the different decorative zones is carried out by means of a cascade control by which a time lag back molding of the different decorative zones is realized.

2. Method according to claim 1,
characterized in that the surface of the second decorating zone is directly formed on the support through the image of the mold surface.

3. Method according to claim 1,
characterized in that the surface of the second decorating zone is being formed by means of a second decorating foil placed in the mold, wherein the first decorating foil overlaps the second decorating foil in its marginal area.

4. Method according to claim 3,
characterized in that the overlapping area of the decorating foils is 1 to 60 mm.

5. Method according to claim 3, characterized in that the overlapping area of the decorating foils is preferably 10 to 20 mm.

6. Method according to claim 1, characterized in that the decorating foils includes textiles, decorating fabric, plastic foils, rug fabric, leather or leather imitations.

7. Method according to claim 1, characterized in that the positioning of the decorating foils in the mold is carried out by means of pins.

8. Method according to claim 1, characterized in that the positioning of the decorating foils is carried out via elements outside the cavity.

9. Method according to claim 1, characterized in that the thermoplastic material includes polypropylene (PP), polyethylene (PE), polyurethane (PU), acrylnitril-butadiene-styrene/polycarbonate copolymerisate (ABS-PC) and polyamid (PA).

10. Method according to claim 9,
characterized in that the thermoplastic material includes reinforcement materials such as, for example, glass fibers, natural fibers or carbon fibers.

11. Method according to claim 1, characterized in that the back molding is carried out by means of back foaming, back injection molding, back compression molding or injection-compression.

12. Use of a molded part produced according to claim 1 as interior paneling for motor vehicles, in particular dash boards, door paneling or side paneling.

13. Device for the production of a molded part according to claim 1, wherein the device includes a mold with cascade controlled injection nozzles for the time-delayed back molding of different decorating zones.
